(19) United States
(12) Patent Application Publication
(10) Pub. No.: US 2012/0128228 A1
(43) Pub. Date: May 24, 2012

(54) Method for Matching of Patterns

(75) Inventors: Akira Fujimura, Saratoga, CA (US); Thomas Kronmiller, Chapel Hill, NC (US); Etienne Jacques, Sunnyvale, CA (US); Harold Robert Zable, Palo Alto, CA (US)

(73) Assignee: D2S, INC., San Jose, CA (US)

(21) Appl. No.: 13/298,350

(22) Filed: Nov. 17, 2011

Related U.S. Application Data
(60) Provisional application No. 61/415,010, filed on Nov. 18, 2010.

(51) Int. Cl. G06K 9/68; G06K 9/00

(52) U.S. Cl. 382/144; 382/218

(57) ABSTRACT

A method for matching of two detailed patterns is disclosed in which abstracts of each of the detailed patterns are created, where the abstracts are less complex than the detailed patterns. The abstracts are then compared to determine if the detailed patterns may possibly match, where comparison of the abstracts is faster than comparison of the detailed patterns. If comparison of the abstracts indicates a possible match, then the detailed patterns are compared, otherwise no detailed pattern comparison is needed.

### RELATED APPLICATIONS

This application claims priority from U.S. Provisional Patent Application Ser. No. 61/415,010 filed on Nov. 18, 2010, which is hereby incorporated by reference for all purposes.

BACKGROUND OF THE DISCLOSURE

Integrated circuit designs are complex, and their design requires processing large amounts of data. Integrated circuit design data is commonly represented hierarchically in most steps of the design process, so as to reduce the volume of data and also to avoid processing the same design information multiple times. Commonly the data is organized into components or cells, with some cells having dozens, hundreds, or even thousands of instances in the design. But particularly in the later design steps, as integrated circuit design data is prepared for manufacturing, the need to account for and to correct for various manufacturing effects tends to cause each cell instance to be processed differently, effectively flattening the design data hierarchy, dramatically increasing the design data volume, and increasing run-times of the design tools because each instance is individually processed. Sometimes, many of the flattened instances end up being identical to each other after all. It is understood by one skilled in the art that an automatic tracking of changes can preserve hierarchy where possible, or re-constitute hierarchy. But often, the coordination required across various tools makes this difficult to accomplish in production design flows. This problem is pronounced particularly when electronic design automation (EDA) tools from multiple vendors manipulate the data in the various design steps.

Manufacturing effects that affect hierarchy include optical lithography effects and charged particle beam lithography effects such as those compensated for by optical proximity effect correction (OPC), source mask optimization (SMO), computational lithography (CL), inverse lithography (ILT), EUV flare correction, mask process correction (MPC) for mask writing including effects of stitching across stripes, proximity effect correction (PEC), fogging effect correction (FEC), loading effect correction (LEC), and EUV mask mid-range correction. All of these effects in various ways affect the eventual shape and size of a pattern on a wafer, depending on the context of the pattern. The immediate or nearby context as well as the distant or far ranging context can affect the eventual shape and size depending on the effect. A given pair of instances of a hierarchical design component or cell that needs to be printed on the wafer identically may print differently because of their immediate and longer-range context being different, if some correction is not made. The corrections that are thus made make the instances different from each other. In current systems, if they are different at all, or even if they could be different, the design data hierarchy is flattened, meaning the contents of a given cell are copied to the location where each cell instance had been, replacing the cell instance. This process increases the amount of data that needs to be stored for the design, thereby increasing the time required for all subsequent processing steps.

For reducing both data volume and processing time, it would be better if similar but different shapes or collections of shapes can be represented hierarchically, but in a parameterized way. Parameterized cells (pcells) is a prior art that addresses this issue in custom layout design. U.S. Pat. Nos. 7,754,401 and 7,759,026, both owned by the assignee of the present patent application and incorporated by reference for all purposes, disclose parameterized glyphs which also address this issue with charged particle beam exposure writing, either with variable shaped beam (VSB) or character projection (CP).

Another need in semiconductor design has come from the exploding design complexity. On a photomask design, for example, a 0.1 nm grid accuracy may be required for designs using a 22 nm process node. The masks are roughly 12 cm on a side, making the mask space a 1.2 G×1.2 G array of pixels. To visualize this vast amount of information, modern systems take advantage of multi-level viewing of the data, where abstractions of the data are created for viewing when “zoomed out”. In other disciplines, movies have long made use of this technology, for example, to zoom in from a picture of the Earth viewed from space all the way to a street in New York City. Google® Earth and the JPEG picture compression are examples of the use of this technique.

### SUMMARY OF THE DISCLOSURE

A method for matching of two detailed patterns is disclosed in which abstracts of each of the detailed patterns are created, where the abstracts are less complex than the detailed patterns. The abstracts are then compared to determine if the detailed patterns may possibly match, where comparison of the abstracts is faster than comparison of the detailed patterns. If comparison of the abstracts indicates a possible match, then the detailed patterns are compared, otherwise no detailed pattern comparison is needed.

### BRIEF DESCRIPTION OF THE DRAWINGS

FIG. 1 illustrates an example of a conceptual flow diagram for matching two patterns using an abstract representation;

FIG. 2 illustrates an example of a detailed representation of a curvilinear pattern;

FIG. 3A illustrates an example of a pixel map abstract representation overlaid with the detailed representation of the curvilinear pattern of FIG. 2;

FIG. 3B illustrates the FIG. 3A pixel map abstract representation of the curvilinear pattern of FIG. 2, without the overlaid detailed representation;

FIG. 3C illustrates the pixel map abstract representation of FIG. 3B, with the pattern re-located to a standard position within the grid;

FIG. 4A illustrates another example of a pixel map abstract representation of the curvilinear pattern of FIG. 2, overlaid with the detailed representation of the FIG. 2 pattern, wherein the grid is offset with respect to the grid in FIG. 3A;

FIG. 4B illustrates the FIG. 4A pixel map abstract representation of the curvilinear pattern of FIG. 2, without the overlaid detailed representation;

FIG. 4C illustrates the pixel map abstract representation of FIG. 4B, but with the pattern re-located to a standard position within the grid;

FIG. 5A illustrates the pixels which are set in the pixel map of FIG. 3C but not in the pixel map of FIG. 4C;

FIG. 5B illustrates the pixels which are set in the pixel map of FIG. 4C but not in the pixel map of FIG. 3C;

FIG. 6A illustrates an example of a curvilinear pattern;

FIG. 6B illustrates an example of a curvilinear pattern similar to the pattern of FIG. 6A, but with the pattern edges expanded in both the x and y directions;

FIG. 6C illustrates an example of a curvilinear pattern similar to the pattern of FIG. 6A, but with the pattern edges expanded in only the x direction;

FIG. 6D illustrates an example of a curvilinear pattern similar to the pattern of FIG. 6A, but with the FIG. 6D pattern incorporating another curvilinear pattern in its upper-left part compared to the FIG. 6A pattern;

FIG. 6E illustrates an example of a curvilinear pattern similar to the pattern of FIG. 8A, but with the bottom of the FIG. 6E pattern truncated;

FIG. 7 illustrates an example of a conceptual flow diagram for performing MDP processing with partial matches; and

FIG. 8 illustrates an exemplary conceptual flow diagram for manufacturing an integrated circuit.

### DETAILED DESCRIPTION OF THE EMBODIMENTS

The current description relates to automatic identification of large-scale repeated patterns, in particular, in any physical data, not limited to physical design of semiconductor devices, in two dimensions, three dimensions, or any dimensional space. A method is disclosed for efficiently determining exact or approximate matches of patterns, using a plurality of representations, including abstract representations, of the patterns. A high-level abstract representation is first used for matching, so as to rule out patterns that clearly do not match. For patterns which are possible matches, successively more detailed representations can be compared to determine exact matches. The abstract representations may also be used to find approximate matches. This method may be especially efficient if most patterns being compared indicate no match. Where the patterns are integrated circuit design patterns, a method is also disclosed for improving processing speed for operations such as mask data processing (MDP) where approximately matching patterns are found.

In the map of the world, there are no two continents or countries with similar shape. However, as an example, consider that at one point in time there were two continents the exact shape of Africa but with differing locations and differing climate and neighboring conditions. So over time, they have become similar but different geographical shapes. For example, one may have had a volcanic eruption, or one may have had a large meteor impact it. In addition, the different climates have caused different human developments on each, so terrain and vegetation changes have over time created a distinct landscape. These two “Africas” have substantially the same overall shape when viewed from space. But they are entirely different in detail if, for example, a person was actually standing in relatively the same location in each Africa. In other locations the two Africas may be unrecognizable from each other.

If it was important to devise an automatic computer algorithm to identify the two Africas as being nearly identical in the large scale, even though they are different in detail, the pattern matching must be done at a larger scale or abstraction, which omits much of the detail.

In addition, speed of execution is an important practical factor in pattern matching. So in designing a pattern matching computer algorithm for large scale pattern matching, it is important to devise a way to quickly separate candidate matches in the large from the majority of the comparisons that end up being not a match. This is the case whether the desired match is for an exact match (even in detail) or for an approximate match, like the two Africas example above.

The present invention provides a technique to use one or more abstract views of the data to do large scale pattern matching more efficiently. The invention covers all disciplines where a very large scale difference exists between the detailed view and the abstract views, and where pattern matching is desired. The following description is specific to integrated circuit design and in particular to the design of a photomask.

In integrated circuit photomask design, there is a large scale difference between the 0.1 nm details of the design and, for example, the 500 μm size of repeated or nearly-repeated patterns that are the building blocks of the design. Representing the data at a 0.1 nm resolution would therefore cause a pattern matcher to process a very large amount of data. It is therefore desirable to represent the design data abstractly, so that the pattern matcher can process a smaller amount of data, thereby achieving its results faster than if a detailed data representation were used.

In pattern matching of large scale integrated circuit geometries, most patterns are not the same as most other patterns. It is therefore important when comparing a pair of patterns, to determine unmatched patterns as quickly as possible. Especially when exact matches down to, for example, 0.1 nm detail need to be tested, abstract matching using multiple levels of abstraction is employed, starting with the most abstract view, and successively refining the test for matching only if a match is suspected at the higher level of abstraction, meaning a level of abstraction with relatively less detail represented than in lower levels of abstraction.

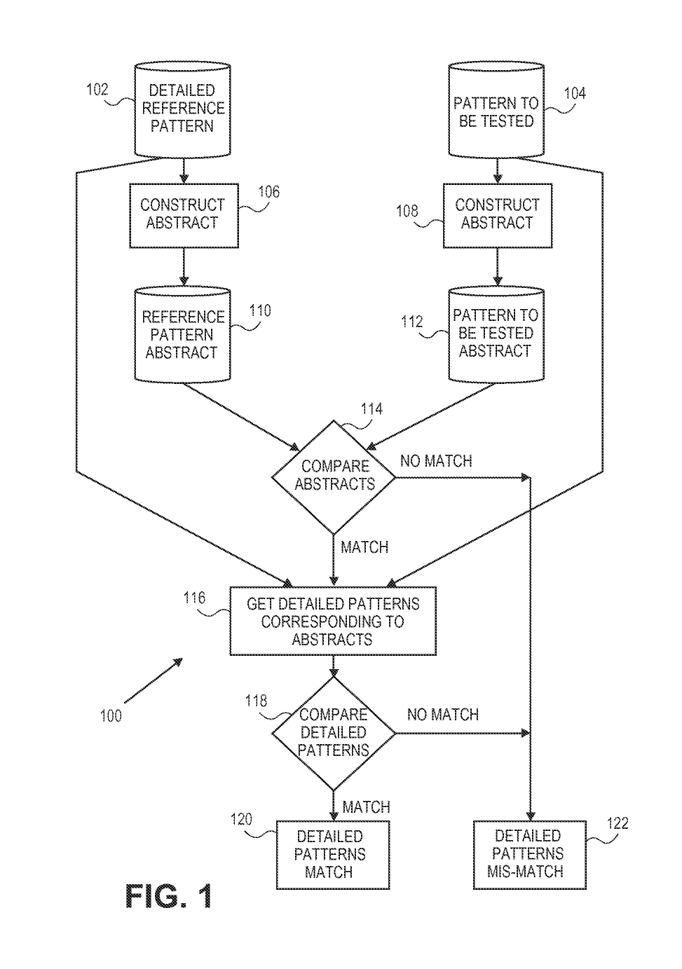

FIG. 1 illustrates an example of an embodiment of the method, where a single pattern is to be compared with a reference pattern using a single level of abstraction. The inputs to the process 100 are reference pattern 102 and the pattern to be tested 104. In step 106 an abstract is constructed from the detailed reference pattern 102 to create reference pattern abstract 110, and in step 108 an abstract is constructed from the pattern to be tested 104 to create an abstract 112 of the pattern to be tested. In some embodiments, construction of the abstracts 106 and 108 may involve an abstract reference grid which is coarser than the grid used for detailed patterns 102 and 104, in which case abstract construction 106 and abstract construction 108 may comprise snapping the pattern to the abstract reference grid. In step 114 the two abstracts are compared to determine whether they match. In some embodiments, a match may be defined as an exact match. In other embodiments, a match may be defined as an approximate match, with a “close enough” match criterion being determined by one or more parameters. In embodiments where an abstract reference grid is used, the comparison step 114 may comprise “forgiving” apparent mismatches due to grid snapping differences caused by detailed pattern to be tested 104 having a different grid offset than detailed reference pattern 102. If the abstracts do not match, then the process is done, with the result 122 that the detailed patterns do not match. If the abstracts match, then in step 116 the detailed patterns corresponding to the abstracts are retrieved, and in step 118 these detailed patterns are compared, which will result either in a match of the detailed patterns 120 or no match of the detailed patterns 122. In some embodiments, comparison step 114 is at least 10 times faster than comparison step 118. In other embodiments, there may be multiple levels of abstraction, with correspondingly more abstract comparison operations, starting with the highest level of abstraction and progressing to lower levels of abstraction.

Many different types of abstractions are possible. U.S. Pat. No. 8,017,286, owned by the assignee of the present patent application and incorporated by reference for all purposes, discloses a method of representing the energy delivered to a surface with charged particle beam lithography by using a two-dimensional pixel-based dosage map. One embodiment for semiconductor photomask design (design to be defined as including architecture, design, refinement, inspection, verification, and repair) may use the energy dose map of the resist exposing beams—such as charged particle, or laser—in various degrees of abstraction, for example, 0.1 nm, 100 nm and 100 μm grids. In addition, an anti-aliased pixel map may be created at similar resolutions, in essence “taking a picture” at various zoom levels of the design to capture large scale features. Other general features, such as total dose, or maximum dose, or charged particle beam shot count, or total exposed area as percentage per grid, or total number of vertices in the shapes, total number of shapes, or total data size may be used as abstractions of the design. One abstraction or a combination of these abstractions in some specific mathematical computation can form a signature, which can then be compared to identify the large scale matches. Any number of pattern matching techniques can be deployed. In the 0.1 nm/100 nm /100 μm example described above, first such a pattern matching is done at the 100 μm grid level, then only those suspected pattern matches will be examined at the 100 nm grid level to further inspect whether the patterns match or not.

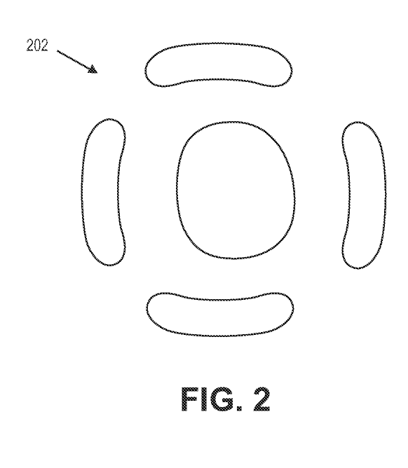

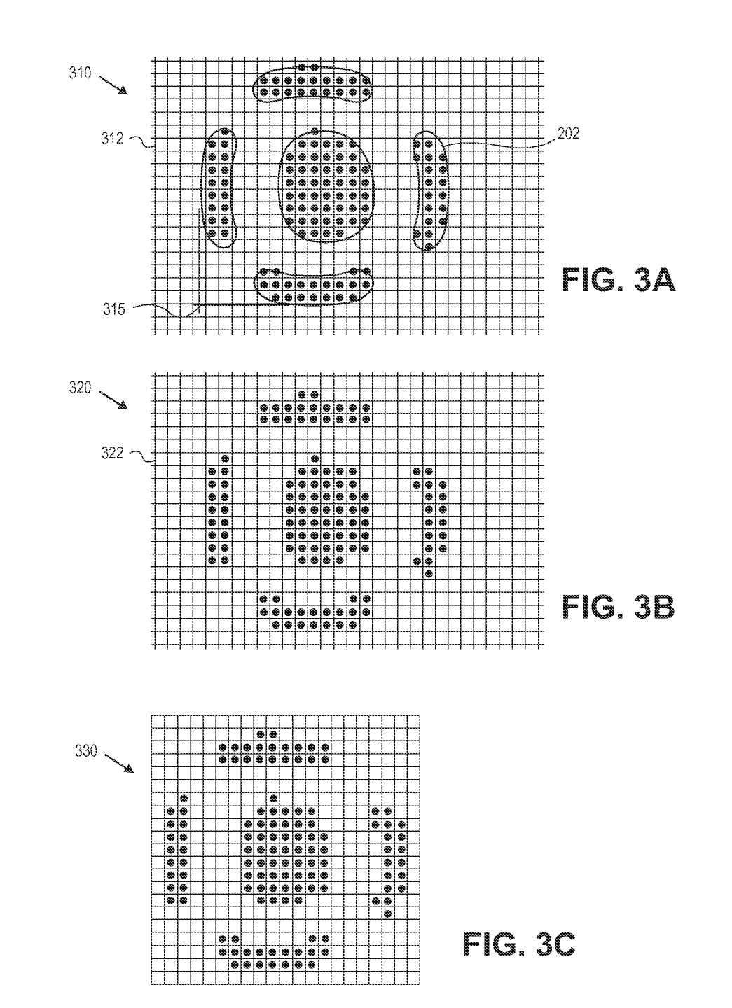

FIG. 2 illustrates an example of a detailed pattern 202, in this example a curvilinear pattern. FIG. 3A illustrates an example of one embodiment of an abstraction 310 of pattern 202, overlaid with pattern 202. Abstraction 310 is a pixel map representation of pattern 202, where one bit is stored for each pixel. Also illustrated in FIG. 3A is the grid 312 within which pixel map 310 is aligned. As can be seen, a bit is set in the abstract pixel map 310 where a majority of a grid square is enclosed within the perimeter of pattern 202. Location 315 designates the lower-left corner of pattern 202. As can be seen, location 315 is offset from the grid lines of grid 312. FIG. 3B illustrates a pixel map 320 on a grid 322, where pixel map 320 is the same as the pixel map 310 but without overlaid pattern 202. Pixel map abstraction 320 may be compared to other similar pixel map abstractions more quickly than two detailed patterns such as pattern 202 can be compared.

In creating abstract representations of integrated circuit physical design data, pixel maps have some advantages compared to, for example, pattern outline representations. In patterns which have been calculated from a plurality of charged particle beam shots, for example, the pattern edges are somewhat blurred due to a variety of short-range physical effects associated with the charged particle beam writer, such as forward scattering, Coulomb effect and resist diffusion, which together are called beam blur.

When generating, for example, pixel map abstracts from two detailed patterns, even if the detailed patterns match exactly, different abstracts may be created, depending on how the detailed patterns align with the relatively coarse grid used for the abstract representation. When comparing abstracts, therefore, the comparison operation must forgive abstract mis-matches which may be caused by offsets in origin.

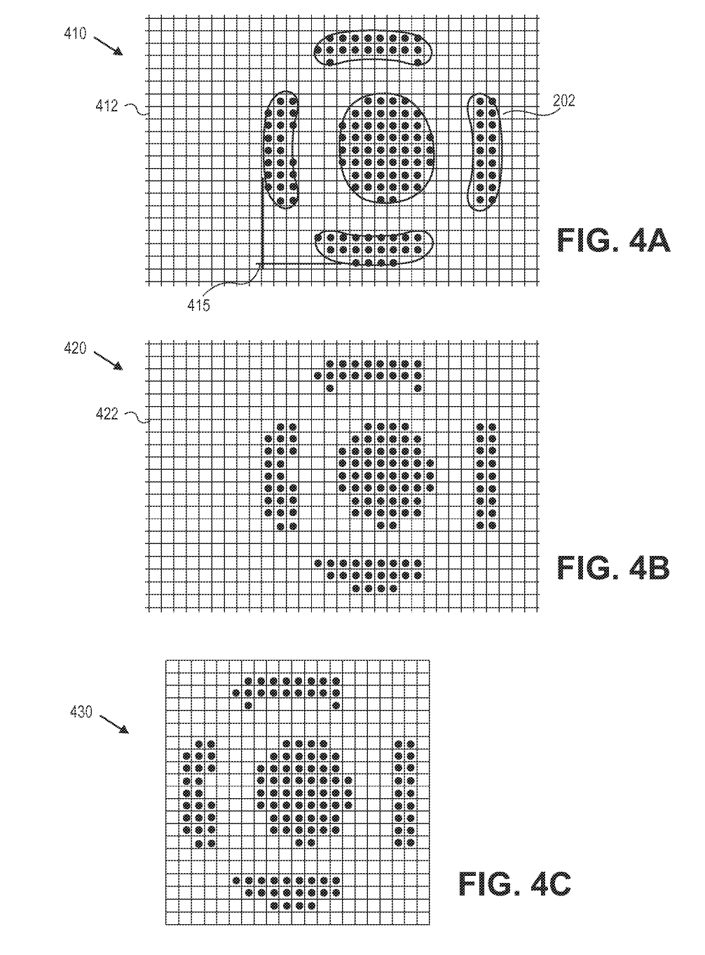

FIG. 4A illustrates another example of an abstract pixel map 410 of pattern 202, overlaid with pattern 202. Like abstract pixel map 310, abstract pixel map 410 uses one bit per pixel. Also illustrated in FIG. 4A is the grid 412 within which pixel map 410 is aligned. Grid 412 has the same grid size as grid 312. Location 415 designates the lower-left corner of pattern 202 in grid 412. As can be seen, location 415 is offset from the grid lines of grid 412 by a different distance in both x and y than the offset of location 315 from grid 312. As can be seen in comparing FIGS. 3A and 4A, pixel map 420 is different than pixel map 320 because of the effect of grid snapping the pattern 202 to a coarse grid during abstract generation, where the grid offset of pattern 202 from grid 412 is different than the offset of pattern 202 from grid 312. FIG. 4B illustrates pixel map 420 on a grid 422, where pixel map 420 is the same as pixel map 410 but without pattern 202 overlaid.

Comparison of pixel maps requires that grid alignment issues be addressed. There are two different alignment issues:
Alignment of the pixel maps to within one grid unit or square.
Forgiving mis-matches caused by differing alignments of the two detailed patterns with respect to the grid, as illustrated in FIG. 3A and FIG. 4A.
   The first issue will be addressed first.

Referring again to FIG. 3B and FIG. 4B, it can be seen that if grid 322 were directly overlaid on grid 422, the patterns 320 and 420 would be mis-aligned by many pixels. In one embodiment, the patterns may be aligned to within a pixel by moving the pattern within the grid or, looked at another way, trimming the grid around the pattern. FIG. 3C illustrates an example of a pixel map 330 which is based on pixel map 320, but where the grid has been trimmed to be one grid square larger than pixel map 320 on all sides. Similarly, FIG. 4C illustrates an example of a pixel map 430 which is based on pixel map 420, but where the grid has been trimmed to be one grid square larger than pixel map 420 on all sides.

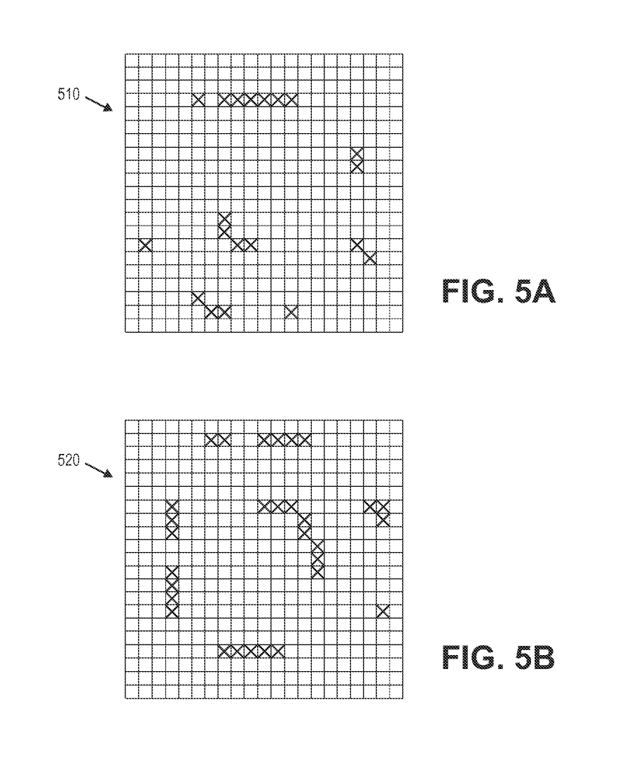

FIG. 5A illustrates a pixel map 510 which illustrates, using an X mark, each grid or pixel which is set in pixel map 330 but not in pixel map 430. Similarly, FIG. 5B illustrates a pixel map 520 which illustrates each grid or pixel which is set in pixel map 430 but not in pixel map 330. Pixel maps 510 and 520 illustrate the effects of grid alignment differences. As can be seen, all differences are one pixel wide. Specifically, in pixel maps 510 and 520, there is no 2×2 group of pixels in which all four pixels in the group are X-marked. More generally, forgiveness techniques will depend on the type of abstract used.

In other embodiments, an abstract reference grid may be used as in FIGS. 3A-3B and FIGS. 4A-4B, but with each pixel represented by more than one bit, permitting more than two possible values to be represented for each pixel. When anti-aliasing is used to create a pixel map abstract from a detailed pattern, the value of pixels near an edge in the original pattern is interpolated so that each pixel may have values in addition to the binary values of “on” and “off”. In one embodiment each pixel may be used to represent a charged particle beam dosage, such as a dosage calculated using charged particle beam simulation. When using pixel maps which store more than one bit per pixel, the comparison operation may comprise, for example, applying a smoothing function to the stored function values, or may comprise taking one or more derivatives of the values.

It can also be useful to find imperfect or approximate matches. In one embodiment, a matching criterion may be, for example, “edges within 30 nm of each other.” In another embodiment a matching criterion may be, for example, “centerline within 2 nm of each other.” In another embodiment, a matching criterion may be, for example, “at least 80% of the edges match within 20 nm.” In such cases, computational processing of the ensuing steps in the design process can be reduced by doing some of the computation only once for each set of approximately matched patterns. The reduction can occur in combinations of two forms. The first form of a reduction is in data volume and associated computational time. For example, a complex polygonal shape may be repeated multiple times in the design. But each instance may have different size biasing where, for example, all edges of the shapes are uniformly extended by 2 nm or shrunk by 2 nm. Storing two different instances of all of the coordinates or mathematical expressions that would produce the two outline shapes would take more space than storing the general shape only once, and then storing with each instance of the shape with a bias amount, such as “2 nm” or “−2 nm.” Since storage and retrieval of large amounts of data takes time and is often the bottleneck in computational processing, reduction in time of computation can be accomplished via a reduction in computational storage space.

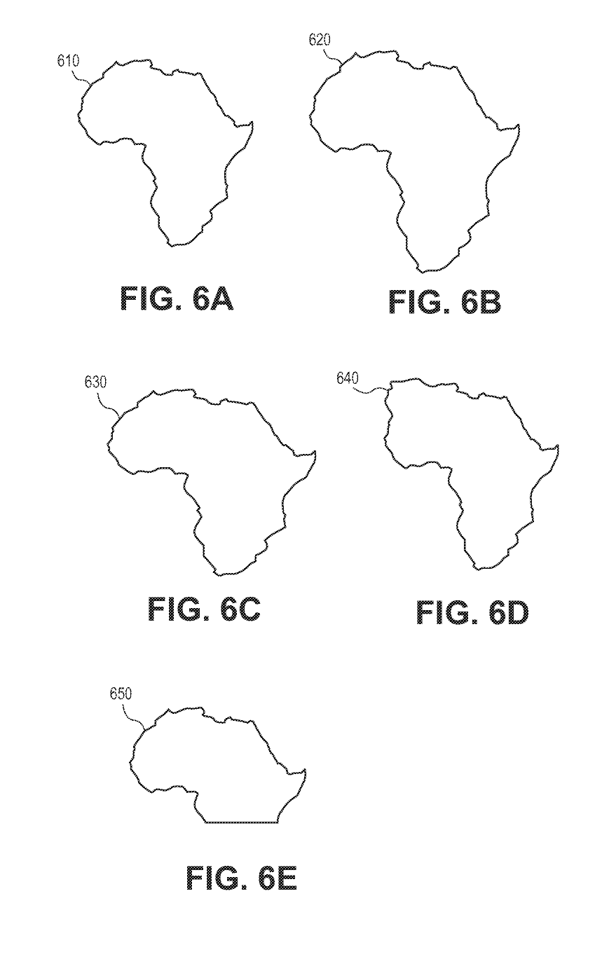

FIGS. 6A-E illustrate examples of partial matching in which computation time may be reduced utilizing the methods of the present disclosure. FIG. 6A illustrates an example of a pattern 610 which is similar to an outline of the continent of Africa. FIG. 6B illustrates an example of a pattern 620 which is similar to pattern 610, but in pattern 620 the edges have been expanded in both x and y directions compared to pattern 610. FIG. 6C illustrates an example of a pattern 630 which is also similar to pattern 610, but in pattern 630 the edges have been increased in size only in the x direction, compared to pattern 610. FIG. 6D illustrates an example of a pattern 640 which is also similar to pattern 610, however in pattern 640 the upper-left part of the pattern has been modified by, for example, merging into it another curvilinear pattern. FIG. 6E illustrates an example of a pattern 650 which is also similar to pattern 610, except that the bottom of the pattern 650 has been truncated compared to pattern 610. Any other form of modification of a reference pattern can also be subject to approximate pattern matching. Scaling, dose modulation, area union (also known as OR), area intersection (also known as AND), union-minus-intersection (also known as exclusive OR or XOR), or any other mathematical operation can create variations of a reference pattern. A comparison operation using approximate matching criteria may comprise determining if a test pattern is a variation of a reference pattern by applying a set of operations to the test pattern. In one embodiment, the set of operations applied in the comparison would be the inverse of a set of operations suspected of having been previously used to create the test pattern from the reference pattern.

Approximate matches may also allow a reduction in computational time by processing the data with as much of the processing being shared as possible. For example, in one embodiment, there may be a shot generation computational step during MDP followed by detailed placement and sizing of the data. All approximately matched parts may go through the shot generation step once, but go through the detailed placement and sizing part individually. The consolidation of processing all approximately matched parts together reduces time compared to performing shot generation for each part separately.

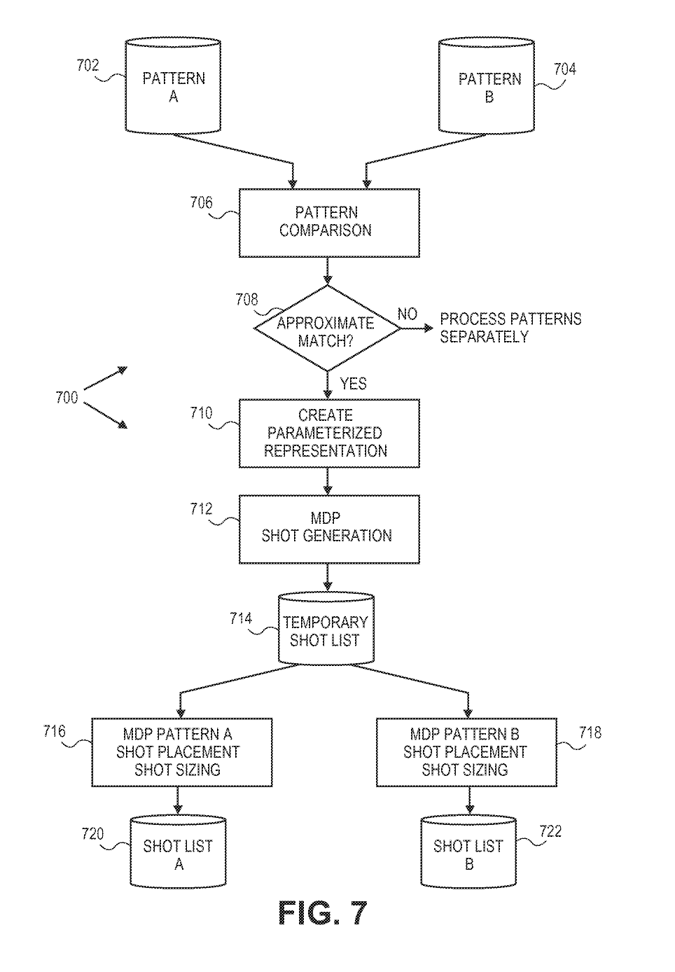

FIG. 7 illustrates an example of one embodiment of an MDP flow 700 using approximate matching. Pattern A 702 and pattern B 704 are two possibly-matching patterns in an integrated circuit design. In step 706 pattern A and pattern B are compared to determine if an approximate match exists. Pattern comparison 706 may include creation and comparison of abstracts of patterns A and B. In testing the results of the comparison in step 708, if patterns A and B are not approximate matches, then they are processed separately using conventional methods, whereas if patterns A and B approximately matching, then a single parameterized representation is created from pattern A and pattern B in a step 710. In step 712 MDP shot generation is performed on the parameterized representation, creating a temporary shot list 714. The temporary shot list 714 is used as input to MDP shot placement and sizing module 716 for pattern A and MDP shot placement and sizing module 718 for pattern B. In other embodiments, modules 716 and 718 may use other shot modification techniques such as changing dosage of a shot and adding an additional shot, instead of or in addition to shot placement and shot sizing. The output of the shot sizing module 716 is shot list 720, and the output of shot sizing module 718 is shot list B 722. Flow 700 may enable reduction in the time required to perform MDP processing on patterns A and B compared to processing each pattern individually.

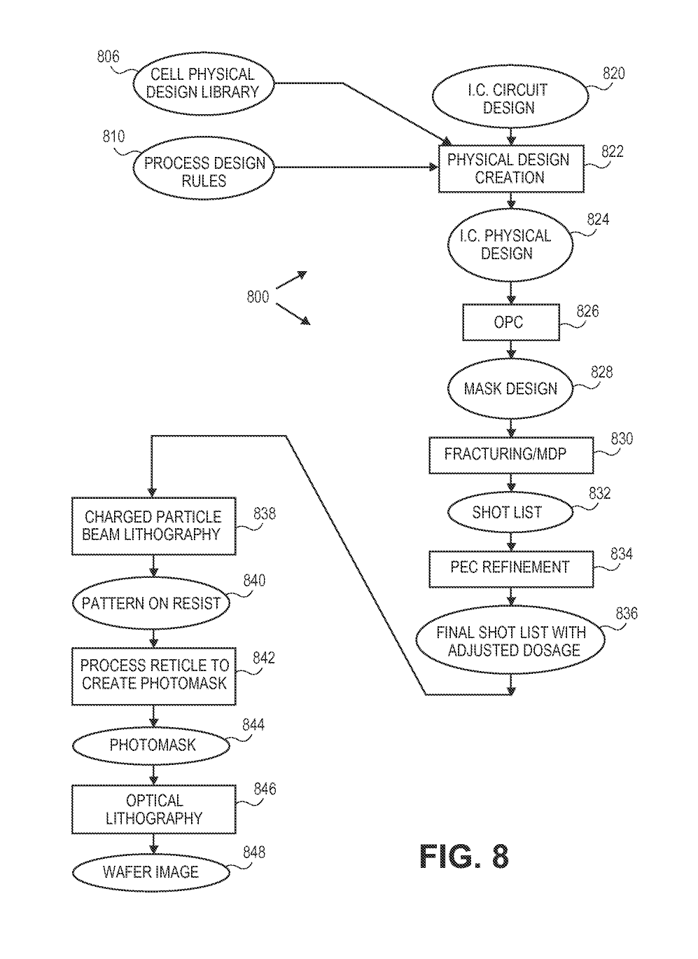

FIG. 8 is an exemplary conceptual flow diagram 800 of a method for manufacturing an integrated circuit according to one embodiment of the current disclosure. The inputs to the process are a cell physical design library 806, a circuit design 820 for the integrated circuit, and a set of process design rules 810. The cell physical design library 806 may include designs for logic functions such as NAND gates, NOR gates and various flip-flops, and may also include, for example, static random access memory (SRAM) designs. The first step in the overall process is physical design creation 822, which creates an I.C. physical design 824, the I.C. physical design 824 being a set of patterns on each of a plurality of layers. The physical design creation 822 process, when using cells from the cell physical design library 806 may preserve all or some of the hierarchy or cell structure. Therefore, in the physical design 824, at least some of the patterns are organized into cells, including cells from the cell physical design library 806, with some cells being repeated many times, even hundreds or thousands of times. Cells that are repeated can be described as having multiple cell instances. The physical design 824 may also comprise repeated groups of patterns which are not organized into cells. Optical proximity correction (OPC) 826 may be performed on the I.C. physical design 824 to produce a mask design 828. OPC 826 may comprise modifying patterns in different instances of a cell differently, thereby destroying the cell repetition. OPC may also comprise “flattening” one or more cell instances in the physical design, so that patterns formerly in these cell instances are moved to a parent cell in the cell hierarchy and the original cell instances no longer exist. OPC may also comprise changing the cell hierarchy so that, for example, patterns in two instances of the same cell in the physical design 824 are output from OPC 826 as instances of two different cells in the mask design 828, even though the patterns within the two cell instances still match. In a fracturing or mask data preparation (MDP) process 830, a set of charged particle beam shots or shot list 832 is determined which can form the patterns of the mask design 828 on a resist-coated surface such as a reticle. In one embodiment, each shot in the shot list 832 may comprise a dosage. In another embodiment, the shots in the shot list 832 may have unassigned individual shot dosages. In one embodiment, the fracturing/MDP process 830 may comprise finding matching sets of patterns in the mask design 828, and using this repetition information to improve the performance of fracturing/MDP 830. The pattern matching process may comprise building and comparing abstract representations to improve the pattern matching speed. In some embodiments the fracturing/MDP process 830 may generate complex CP shots. In other embodiments the fracturing/MDP process 830 may generate only VSB shots. Proximity effect correction (PEC) 834 may then be performed on the shot list 832 to create a final shot list with adjusted dosages 836. The final shot list 836 is used by a charged particle beam writer to expose a resist-coated reticle in step 838 to create a pattern 840 on a resist-coated reticle. The reticle containing the resist pattern 840 is processed in step 842 to create a photomask 844. The photomask 844 is used in an optical lithographic process 846 to transfer the mask pattern to a resist-coated wafer.

In other flows, efficient matching of patterns may be used to improve performance of OPC, mask verification, MPC, SMO, ILT, EUV flare correction, PEC, FEC, LEC, EUV mask mid-range correction, or mask stitching across stripes of a charged particle beam writer.

The OPC, SMO, CL, ILT, EUV flare correction, MPC, PEC, FEC, LEC and EUV mask mid-range correction flows described in this disclosure may be implemented using general-purpose computers with appropriate computer software as computation devices. Due to the large amount of calculations required, multiple computers or processor cores may also be used in parallel. In one embodiment, the computations may be subdivided into a plurality of 2-dimensional geometric regions for one or more computation-intensive steps in the flow, to support parallel processing. In another embodiment, a special-purpose hardware device such as a graphics processing unit (GPU), field programmable gate array (FPGA), or application-specific integrated circuit (ASIC), either used singly or in multiples, may be used to perform the computations of one or more steps with greater speed than using general-purpose computers or processor cores.

In parallel processing of large amounts of data, where there are many computational nodes processing different parts of the design simultaneously, a careful balancing of the reduction in data size and reduction in data processing allows optimal overall performance.

While the specification has been described in detail with respect to specific embodiments, it will be appreciated that those skilled in the art, upon attaining an understanding of the foregoing, may readily conceive of alterations to, variations of, and equivalents to these embodiments. These and other modifications and variations to the present method for finding matches among geometrical patterns, may be practiced by those of ordinary skill in the art, without departing from the spirit and scope of the present subject matter, which is more particularly set forth in the appended claims. Furthermore, those of ordinary skill in the art will appreciate that the foregoing description is by way of example only, and is not intended to be limiting. Thus, it is intended that the present subject matter covers such modifications and variations as come within the scope of the appended claims and their equivalents.

What is claimed is:

1. A method for matching detailed patterns, the method comprising the steps of:
creating a first abstract representation of a first detailed pattern and a second abstract representation of a second detailed pattern, wherein each of the first and the second abstract representations is less complex than the first and the second detailed pattern respectively;
comparing the first abstract representation to the second abstract representation in a first comparison to determine if a possible match exists; and
comparing the first detailed pattern to the second detailed pattern in a second comparison when the first comparison indicates a possible match,
wherein the first comparison of the first and the second abstract representations is faster than the second comparison of the first and the second detailed patterns.

2. The method of claim 1 wherein the first and the second abstract representations comprise anti-aliased pixel maps.

3. The method of claim 1 wherein the first and the second abstract representations are created with respect to an abstract reference grid, wherein the first abstract representation has a first offset with respect to the abstract reference grid, wherein the second abstract representation has a second offset with respect to the abstract reference grid, and wherein the second offset of the second abstract representation is different than the first offset of the first abstract representation.

4. The method of claim 1 wherein first and the second abstract representations represent integrated circuit design patterns.

5. The method of claim 4 wherein the matching is part of mask data preparation (MDP).

6. The method of claim 4 wherein the matching is part of optical proximity correction (OPC).

7. The method of claim 4 wherein the matching is part of mask verification.

8. The method of claim 4 wherein the matching is part of mask process correction (MPC).

9. The method of claim 1 wherein the first comparison of the first abstract representation and the second abstract representation is at least 10 times faster than the second comparison of the first detailed pattern and the second detailed pattern.

10. The method of claim 1 wherein the first and the second detailed patterns are integrated circuit design patterns, and wherein the first detailed pattern and the second detailed pattern are to be formed on a surface using charged particle beam lithography, the method further comprising the step of determining one set of charged particle beam shots which is capable of forming either the first or the second detailed patterns, when the second comparison of the first and the second detailed patterns determines that the first and the second detailed patterns are an approximate or exact match.

11. The method of claim 1 wherein the first and the second detailed pattern are integrated circuit design patterns, and wherein in the step of comparing the first and the second detailed patterns, an approximate match is determined.

12. The method of claim 11, further comprising the step of generating a parameterized pattern which can represent both the first and the second detailed patterns.

13. The method of claim 12 wherein the first and the second detailed patterns are stored as instances of a parameterized glyph.

14. The method of claim 11, the method further comprising the step of using the approximate match in a processing operation selected from the group consisting of mask data preparation (MDP), optical proximity correction (OPC), mask verification, source mask optimization (SMO), computational lithography inverse lithography (ILT), EUV flare correction, mask stitching across stripes of a charged particle beam writer, proximity effect correction (PEC), fogging effect correction (FEC), loading effect correction (LEC), EUV mask mid-range correction and mask process correction (MPC).

15. The method of claim 14 wherein the processing operation of the first and the second detailed patterns are at least partially shared.

16. The method of claim 15 wherein the first and the second detailed patterns include matched and/or approximately-matched parts, and differing parts, and wherein the processing operation comprises the steps of:
processing the matched and approximately-matched parts of the first and the second detailed patterns together; and
processing separately the differing parts of the first and the second detailed patterns.

17. The method of claim 14 wherein the processing operation is MDP, and wherein a single set of shots is generated for both of the two detailed patterns.

18. The method of claim 17 wherein a shot modification technique is used to create from the single set of shots two unique shot lists for the first detailed pattern and the second detailed pattern.

19. The method of claim 18 wherein the shot modification technique is selected from the group consisting of changing the dosage of a shot, changing the position of a shot, changing the size of a shot, and adding an additional shot.

20. A method for matching detailed patterns, the method comprising the steps of:
creating a first plurality of abstract representations of a first detailed pattern and a second plurality of abstract representations of a second detailed pattern, wherein the first and the second pluralities of abstract representations have ranges of lower to higher complexities, wherein each abstract representation in the first plurality of abstract representations is less complex than the first detailed pattern, wherein each abstract representation in the second plurality of abstract representations is less complex than the second detailed pattern, and wherein for each first abstract representation in the first plurality of abstract representations, there is a second abstract representation in the second plurality of abstract representations at the same level of complexity;
comparing a low complexity first abstract representation in the first plurality of abstract representations with a second abstract representation in the second plurality of abstract representations, wherein the level of complexity of the second abstract representation is the same as the level of complexity of the first abstract representation;
comparing a pair of first and second abstract representations of a higher level of complexity when the comparison of abstract representations of a lower level of complexity indicates a possible match; and
comparing the first detailed pattern to the second detailed pattern when all the comparisons of abstract representations in the first and the second pluralities of abstract presentations indicate a possible match.

21. A system for fracturing or mask data preparation (MDP) for use with charged particle beam lithography comprising:
a set of input patterns;
a device capable of creating at least one abstract representation of each input pattern in the set of input patterns;
a device capable of comparing the abstract representations of different input patterns to determine possible matches between pairs of input patterns;
a device capable of comparing patterns in the set of input patterns, when comparison of the abstract representations indicates a possible match between pairs of input patterns; and
a device capable of determining a set of charged particle beam shots which is capable of forming the set of input patterns on a surface, wherein processing of exactly matching patterns, or of exactly or approximately matching patterns, is shared.

22. The system of claim 21 wherein the abstract representations are created with respect to a reference grid.

23. The system of claim 22 wherein the abstract representations comprise anti-aliased pixel maps.

24. The system of claim 21 wherein a plurality of abstracts is created for each of a plurality of input patterns in the set of input patterns.
